(19) United States
(12) Patent Application Publication
(10) Pub. No.: US 2010/0257015 A1
(43) Pub. Date: Oct. 7, 2010

(54) GRAPHICAL CLIENT INTERFACE RESOURCE AND WORK MANAGEMENT SCHEDULER

(75) Inventor: Bradley Molander, St. Charles, MO (US)

Correspondence Address: HUSCH BLACKWELL SANDERS LLP, 190 Carondelet Plaza, Suite 600, ST. LOUIS, MO, 63105, US

(73) Assignee: NATIONAL INFORMATION SOLUTIONS COOPERATIVE, INC., Lake St. Louis, MO (US)

(21) Appl. No.: 12/416,899

(22) Filed: Apr. 1, 2009

(51) Int. Cl. G06Q 10/00; G06F 3/048; G06F 17/30

(52) U.S. Cl. 705/9; 715/769; 715/835; 707/E17.014; 707/E17.044

(57) ABSTRACT

A computer implemented system and method that ties in complex calendar event relationships, which provides the user with a context as to how the task needs to be completed and how it relates to larger initiatives. The system and method supports next to real time notification methods using a peer-to-peer (p2p) messaging architecture. As Calendar Events or Tasks are manipulated in the Work Management System, all scheduling clients can automatically adjust their events to reflect the changes. The present invention can also implement an Urgency Factor for tasks which can help visualize to the user which tasks need more immediate action from Work Management. The present invention can also provide a First Available function that not only finds the first available date that a task can be worked but also takes into consideration the resource's work hours, workdays and skill set via the work group that they have been assigned.

### BACKGROUND OF INVENTION

1. Field of Invention

This invention relates generally to work management systems and, more particularly, to systems for scheduling and managing resources and tasks.

2. Background Art

Most work management systems and scheduling applications are texted based and calender/timeline oriented and do not provide a more robust graphic driven interface. Scheduling programs are quite useful for project-oriented tasks for various professions such as field service engineering companies (utility companies), product engineering companies, construction firms, and manufacturing companies. Scheduling programs allow a customer service manager, in the case of field service engineering companies, and project manager, in the case of manufacturing companies to organize and track the development of a project. In the case of a field service engineering company, a scheduling program can be initiated by receiving an input of task or project related information related to for example a customer order, generating a schedule based on this information, and then graphically or in a tabular manner, displaying the details concerning the schedule.

Computer based applications can be used to manage tasks that are to be completed for a desired project. These type of applications are often referred to as a project management application. A user can typically define, plan, and schedule tasks that must be completed to achieve a goal. A project management application program helps the user define project goals, plan tasks and resources, display a project plan, carry out and manage the project. Project management applications can provide functions for automatically calculating the project schedule; automatically updating the project schedule if task information is changed; analyzing the project schedule; scheduling resources; and providing schedule output in a standard format which is consistent for all projects.

A project management schedule can be composed of tasks. The schedule defines the sequence in which the tasks must occur, the resources needed to complete a task, and calendar information about the tasks such as days and times. Each task is defined to include such information as its start and finish day and time, the percent of work complete, the resources it uses, and the actual cost, etc. Project schedules containing task information are typically displayed by three methods in the prior art. These three methods are Tables, Gantt Charts, and PERT Charts.

Various scheduling methodologies can be utilized, for example, the critical path method (CPM) of scheduling is used in a significant number of scheduling programs. CPM scheduling generally operates by receiving a list of tasks, each task having varying restrictions or constraints, and generating a schedule based on the task restrictions or constraints. More specifically, a set of tasks are provided to the scheduling program. Each task represents a specific job or discrete amount of work that must be performed on a project. Additionally, each task can have a set of restrictions or constraints which dictate when and how long the task should be performed. To generate a meaningful schedule, CPM scheduling requires the input of information which identifies when each task is to be performed. This information can be provided by specifying constraints such as: a start date and a finish date, a start date and a task duration, a task duration and a finish date, or a task duration and a start or finish date which is dependent upon another task. If this information is not specified, the typical CPM scheduling program will assume the start date for each task to be the current date, and the duration of the task will default to a specific granularity such as one day, one week, etc.

Linking information concerning one or more of the tasks may also be entered. For instance, if a project consists of multiple tasks and whereby, the user may specify that one task must be completed before another task, which must be completed before yet another task. A user of such a system can be a customer service representative or dispatcher in a company having field service engineering division, such a utility company. An input to a scheduling application can be initiated by a customer service call received by a dispatcher or other user of the scheduling application. A customer can request a service order, which can require certain tasks in order to fulfill the customer service order. The user, in this case a dispatcher, can enter the task information, and a CPM scheduling application can generate a schedule based on the provided task constraints.

The critical path can be defined as the longest duration path through the network of task dependencies. The critical path is calculated by performing a reverse calculation from the last finish date to the earliest start date. CPM scheduling programs are most beneficial for projects in which the tasks have dependencies on each other. They are well suited for product-oriented projects which inherently have tasks that must be performed in a specific order. However, order dependencies don't always exist and further, there are various other resource constraints that must be considered and in the area of field service engineering tasks lists will likely change at least daily if not more frequently. CPM scheduling programs of this nature don't provide a full view of such constraints or the overall workflow.

A system and method for creating manpower schedules can be complex, and can involve such variables as the definitions of each task, the percentage of an employee's time that it takes to do a particular task, the day of the week, month, or year in which the task should be performed, the skill levels of employees available to perform each task, resource constraints such as equipment capacity at the location that facilitate or prevent a task from being scheduled, relationships between tasks that affect their placement and movement on the schedule, calculations for each task for a task's length, start time, positive and negative tolerances in completing a task, and employee availability by day of the week, hours of the day, their skill level and priority or seniority levels or categories.

Each remote location remote location where a job is to be performed can have unique differences in layout, topography and access to necessary resources. These differences are further complicated by the uniqueness of each day of the week and seasonality of the year. Such variables must be combined and examined to create a unique optimum manpower schedule for each remote location.

Traditional scheduling programs can work well for scheduling and planning long term projects to determine the scope of effort, to determine cost, to determine manpower required and to determine whether a project is on schedule. However, these traditional scheduling application don't provide the necessary functions for managing resources on a day to day basis when there isn't a long term milestone plan, but where new work flows and new tasks a generated daily and even hourly and placed in queue awaiting assignment of resources and scheduling. Also, priorities for completion of tasks may change daily, particularly as new workflows and tasks are added to the queue for completion. Also, as in the case of a utility provider, there may be a plurality of potential users, for example, dispatchers, resource managers, customer service representatives, or field service group managers who at any point in time may need to have a current view of the highest priority tasks in queue; a current view of resource allocations and availability; a current view of the location of resources; and a current view of the schedule, so that one or more of them may assign resources to tasks, schedule and/or report regarding status of service order. Traditional scheduling applications are inadequate in this regard and are the reason why it is not uncommon for utility providers to be unable to inform a customer regarding specifically when a service order will be performed. Typically a customer is provided with a four (4) hour to eight (8) hour window for arrival.

### BRIEF SUMMARY OF INVENTION

The invention is a computer implemented system and method that ties in complex calendar event relationships, which provides the user with a context and view of how a task needs to be completed and how it relates to larger initiatives and resources available. The system and method supports next to real time notification methods using a peer-to-peer (p2p) type messaging architecture. As with other p2p architecture type computer networks, the present invention can use diverse connectivity between participants in a network to thereby utilize the cumulative bandwidth of network participants rather than conventional centralized resources where a relatively low number of servers provide the core value to a service or application. As with other p2p networks, the p2p network of the present invention can be used for connecting nodes via largely ad hoc connections. Such networks are useful for many purposes including providing next to real time information updates to each of the participants.

A pure p2p network does not have the notion of clients or servers but only equal peer nodes that simultaneously function as both “clients” and “servers” to the other nodes on the network. This model of network arrangement differs from the client-server model where communication is usually to and from a central server. A typical example of a file transfer that is not p2p is an FTP server where the client and server programs are quite distinct: the clients initiate the download/uploads, and the servers react to and satisfy these requests. The typical client server architecture hinders next to real time updates. The participants can selectively act on only that information which is pertinent to that individual participant. Content files can be shared containing data concerning work management or anything in digital format, and can be next to real time data, such as updated scheduling. The present invention can utilize a p2p type architecture while utilizing a work management system as a conduit/data-traffic-coordinator and an interface to a central repository of schedule and task data.

As Calendar Events or Tasks are manipulated in the Work Management System, all scheduling clients can automatically adjust their events to reflect the changes. The Work Management System can be a server application and can reside and be executed on a hardware server that is common with other business applications. It also could reside on a separate dedicated server. The present invention can also implement an Urgency Factor for tasks which can help visualize to the user and provide a priority as to which tasks require more immediate action from Work Management. Again, the Work Management application can act as a coordinator of the p2p network of Scheduler desktops, business-application desktops and mobile handheld devices. The Work Management application can include a scheduler function and a mobile function.

The present invention can also provide a First Available function that not only finds the first available date that a task can be worked but also takes into consideration the resource's work hours, workdays and skill set via the work group that they have been assigned. Urgency factors from the Work Queue can allow tasks to be prioritized based on several factors including—Order in the workflow, task importance, service order priority and critical task switches upstream. Tasks can be colored and assigned a numerical identifier to illustrate their urgency to the user. These tasks can then float to top of the priority lists so that they are graphically in view for the user to take action on.

One aspect of the present invention is a graphical user interface tying into a Work Management engine, where the graphical user interface provides a view to the user that reveals current status of assigned tasks, resource availability and allocation, task queue and calendar of events. Users can see the entire Workflow right from the scheduling screen. This unique integration with the calendar allows the user to see how their calendar task relates to the Work Management Server. Additional task information can be seen from the Work Management Server as well that has little to do with Scheduling. Individual workloads can easily be calculated from the work queue in a graphical manner. This top level view gives dispatchers a quick view of which resources are under utilized and need more work and how much work the entire group is scheduled for. Individual schedules can be observed while tasks are selected and slotted based on first availability. After a task is selected from the work queue, the first available button can be pushed to find the next available time slot based on Work Group and personal schedules. First available calculations are based on Normal Work Schedules, Time off, and meetings.

Service Orders can be created by customer service representatives. These service orders can then be interpreted by the Work Management system to determine “what” and a series of tasks is created in a workflow based on the “what” that describes “how”, “when” and “who”. These tasks will contain specific ordering and can be routed to default workgroups that typically perform the work defined in the task. These tasks can then be assigned and scheduled to individuals or crews at strategic points in time. The tasks within a work flow may all be assigned to an individual workgroup or subdivided and assigned to multiple workgroups based on expertise or workload. These assignments and scheduling functions are made by the Graphical Resource Scheduler and can be consumed by downstream task consuming applications such as Mobile Workforce, Outage Management or Staking. Graphical Resource Scheduler can provide filtering capabilities that help dispatchers restrict the work in view so that volume does not impede the user's ability to efficiently schedule work.

The User can utilized the drag and drop experience for scheduling tasks and booking resources from the work management system. The present invention provides the ability to drag resources or tasks onto each other graphically to dynamically initiate and affect the assignment and scheduling status of a task. A user can click on and select on of the tasks listed in queue and drag the task from the queue window to the calendar area of the screen depicting the calendar for a group and can drop the task at the appropriate case on the calendar, then expand the task to the appropriate duration. A resource can then be selected by clicking on it and dragging it over to the calendar section of the display and releasing over the previously scheduled task. The task has now been assigned. This graphical drag and drop interaction with the user interface can automatically initiate the passing of a data packet to the work management system, which can be translated into a scheduling and notification event, where each of the participants in the network are notified with updated scheduling of tasks and resources.

Geocoding of tasks based on customer discussions can also be performed. One of the tasks in the workflow can ask a customer service representative (CSR) to geo-tag a task to a specific location. The process can prompt the CSR to place a flag on a map displayed graphically so that the service technician knows where to perform their task (further down in the workflow). This process is critical to routing and workload planning in terms of lower drive times and fuel costs. Task assignments and scheduling can be made with location of the work site and location of the resource in view. Using a multi-monitor function, a user can view the calendar/resource/task screen format on one monitor while simultaneously viewing the map/resource location/task screen format on another monitor. Any update resulting from this users input or any other users input will be updated on both screens in a next to real time manner using the p2p type architecture.

The Graphical Resource Scheduler can utilize multiple monitors. Screens can be broken out and moved to additional monitors to provide more detail. This configuration is usually determined by user roles. Dispatchers can typically look at Calendar and Task Completion views. Managers can typically look at Mapping views to see the locations of their fleet. Screens can be renamed and configured based on user preferences. When the Graphical Resource Scheduler starts up after a shutdown, it will appear in the exact same state—saving all window and screen configurations for the user.

One embodiment of the present invention is a computer-implemented method for generating a schedule for a task list to be performed and allocation of resources the method can comprise the step of inputting customer request data into a client desktop. The computer implemented method can perform the step transmitting the customer request data from the client desktop to a server over a p2p type network, where said server is communicably linked to a relational database and said server has a work management application executing thereon and a business application executing thereon, where said work management application is a running p2p coordinator function, a scheduler function and a mobile function.

The work management application can created a work flow including a task and can electronically store the task in the relational database. The method can start a scheduler desktop application on a scheduler desktop and launch a browser like graphical user interface having a workgroup window including a graphical representation of a resource, a calendar window including a graphical representation of available and booked time slots and a task queue window including a graphical representation of the task in view. The computer implemented method can download from the server the task over the p2p network to the scheduler desktop and display the graphical representation of the task in the task queue window. A user can click on the graphical representation of the task and drag a task icon representative of the task to the calendar window and place the task icon in an appropriate available time slot. The computer implemented method can automatically book the appropriate available time slot in the schedule data and upload to the server over the p2p network the task schedule data representative of the booked time slot and updating an event schedule in the relational database. The computer implemented method can transmit the updated event schedule data to all participants on the p2p network and present the updated schedule in the schedule window.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is an illustration of the physical topology on which the applications reside.

FIG. 2 is an illustration of a peer-to-peer network environment including various participants within the work management function;

FIG. 2A is an illustration of the data packets;

FIG. 3 is an illustration of how the scheduler, mobile and Work Management System participate with P2P, Web Services and RMI;

FIG. 4 is an illustration of how to create a service order, generate a workflow of tasks and complete the work flow; FIG. 5 is an illustration of the flow for dispatching work by downloading and scheduling tasks;

FIG. 6 is an illustration of a screen shot of the Workgroup Resource/Calendar View with the task queue in view;

FIG. 7 is an illustration of a screen shot of the Individual Resource/Daily Calendar View with task queue in view;

FIG. 8 is a further illustration of a screen shot of the Individual Resource/Daily Calendar View with task queue in view;

FIG. 9 is an illustration of task tables showing urgency flow;

FIG. 10 is an illustration of the First Available flow for assigning tasks;

FIG. 11 is a screen shot illustrating the First Available function;

FIG. 12 is a screen shot illustrating a Workgroup Workload View with tasks in view;

FIG. 13 is a further screen shot illustrating a Crew Template of the Workgroup Workload View with tasks in view;

FIG. 14 is an illustration of the overall data flow;

FIG. 15 is an illustration of the overall data implementation schema;

FIG. 16 is an illustration of the Service Order Table Flow;

FIG. 17 is an illustration of the Data Template Schema;

FIG. 18 is an illustration of Templates and Tables; and

FIGS. 19 and 19A are screen shots of illustrating Geo-Tagging.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

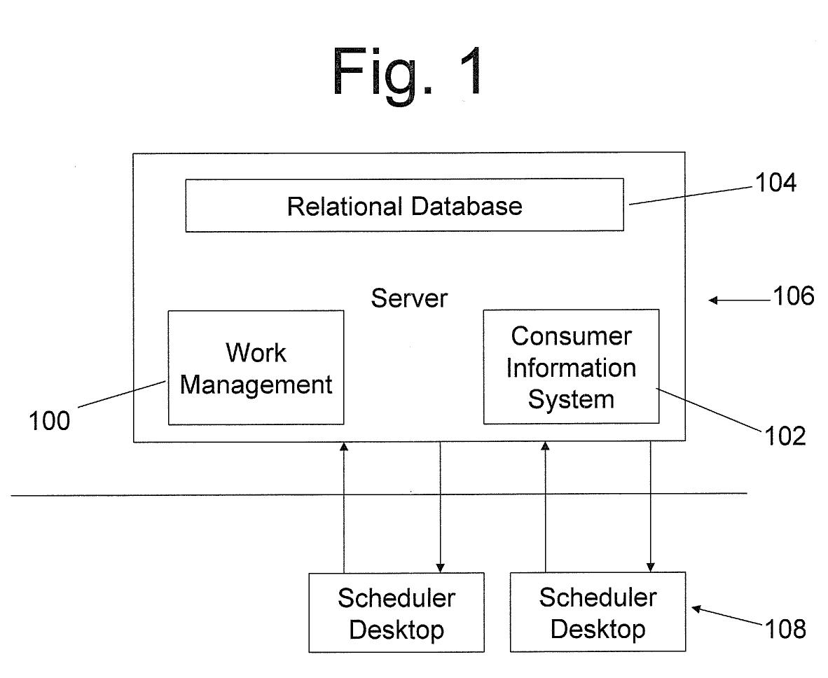

According to the embodiment(s) of the present invention, various views are illustrated in FIGS. 1-19 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a computer implemented method and system for project scheduling, includes a user interface with calendar, resources and task in view, a first available function, and an urgency factor function implemented on a peer-to-peer (p2p) type network, which teaches a novel system and method for tying in complex calendar event relationships, which provides the user with a context as to how the task needs to be completed and how it relates to larger initiatives and availability of resources. Service orders are created responsive to a customer service request and a dispatcher or other user will utilize the scheduler client application to allocate resources, assign and schedule the associated tasks.

Another embodiment of the invention is a computer-implemented method for generating a scheduler user interface for task scheduling and resource allocation and the method can comprise the step of presenting to a user a task view window within a user interface screen displayed on a scheduler desktop computing system where the desktop computing system is a participant in a p2p type network and where the task view window graphically lists a task icon representative of a task to be performed, which is part of a workflow generated based on inputting customer request data into a customer service client desktop defining a service order. The user interface can present a workgroup and resource window within said user interface screen where the workgroup and resource window graphically lists a resource icon representative of a resource. The user interface function can further present a calendar window within said user interface screen where the calendar window includes a calendar graphically illustrating a scheduled event and a scheduled task and available time slots for the resource. The user interface can have a function for operating on the scheduler desktop computing system that is operable to allow a user to click on the task icon, drag and drop said task icon in one of said available time slots and further to allow the user to click on the resource icon, drag and drop said resource icon on the task icon. The system in response can automatically book the appropriate available time slot and resource for the task in task schedule data using a scheduler application operating on said scheduler desktop computing system and uploading to a server over the p2p network the task schedule data representative of the booked time slot and updating an event schedule in a relational database communicable with said server. The updated event schedule data can be transmitted to all participants on the p2p network and presenting the updated schedule on the user interface.

For example, Customer Service Orders can be created for customer service through a customer self-serve website where a customer can request new equipment or new service to their home or business, or the customer can call in their order. A dispatcher or customer service representative can input into a computing system the customer service request information using a scheduler desktop user interface application whereby the computing system can create s service order which effectively documents the work and the equipment that will be contained in the order and that service order in turn generates a workflow in a work management system. The workflow can essentially be the steps or tasks to complete that are required to make that service order happen. The service order can describe the work, equipment and the service that is needed and the workflow can define when and who (type and skill level) is going to do it.

Within the workflow there can be a series of tasks and those tasks can be correlated with the service order to determine which ones to assign where and in which order. The graphical scheduler application can take in the tasks and consume them and drag and drop them or in other words you can assign them and schedule them in a drag and drop fashion through a graphical user interface. Many prior dispatcher systems can't integrate the scheduler application with the work management system. Many prior applications are forced to be a strict calendar system, where there is no direct integration or contextual meaning between calendar events. This can be an automated solution whereby when tasks are identified the scheduler can pull them into the scheduler application and schedule them. Once that task date is scheduled and resources assigned in the interface through scheduler then those tasks can flow to other applications like our mobile application or our local field application where the tasks are actually worked. Some tasks (critical tasks) act as blockers, preventing downstream tasks from processing until complete.

However, at any point in that workflow the tasks can go through several alterations. Tasks can be pulled into the scheduler application as a result of the original input by a dispatcher responsive to a customer service request. However, the mobile application, which can reside on a handheld computing device carried by the field service engineer, can receive inputs from the field service engineer, which could require a few tasks to be added and then due to additional dispatcher inputs more tasks can be pulled as the work goes due to changes in requirements to fulfill the service order. As tasks are added, the first available timings can be identified by using the scheduler application and all the resources and corporate times can be coordinated. As these tasks are assigned and scheduled, the dispatcher can now balance individual resource workloads and determine accurate costs and timeframes associated with the overall workload of the fleet.

The service orders can be kept on a legacy system such as a CIS (Consumer Information System), which is an accounting, billing and customer service application that can communicate to the p2p network. The service orders can contain details concerning the customer service request. Then the work management data of the actual task describes how to do the work and who has to be assigned to perform the work. This data can be in a work management system. The work management system and the p2p network can be in the same area, but they can be of two different resources. When the scheduler application runs, scheduler can operate as a separate client application on a scheduler desktop computer system. Through web services the system will pull the data out of work management for the workflow and out of the CIS for the service order. The user can view the tasks and workflow through scheduler and can schedule an order, and can reference the service order from the CIS. This integration of data with the Work Management System and p2p network is unique to present applications infrastructure and allows for better decision making regarding the management of resources and scheduling of task.

Once the tasks are pulled, the tasks can show up on the bottom of the screen of the user interface of the scheduler client application. Depending on the customer size (the size of the end consumer base of the customer, for example a utility company/provider, e.g. the number of meters), there can be thousands to hundreds of thousands of tasks that can be pulled off and scheduler can provide a series of filters that allow dispatcher to filter down by locality, area of service territory, or the type of work to which that task is pertaining. The filters can be automatic or selected by the user. Also, scheduler can calculate an urgency factor based on certain weighted parameters. If a particular parameter applies a plus or minus factor may be applied to an urgency number.

For example, each task can be assigned a number between 0 and 100 to identify the level of urgency with 100 being the most urgent. The urgency function can take all of the tasks and can put them in a hierarchical order so the dispatcher or other user knows which ones to work with first. For example their might be 5,000-6,000 active tasks that are ready to be worked, however, in a given day the field service engineering division can only do 200-300 at the most. Therefore, scheduler can move tasks that are due sooner or pertain to larger accounts—to the top. When the tasks show up on the bottom of the screen after being filtered the user can determine which ones are most important. The user interface of the scheduler client application will allow the user to simply drag and drop those tasks up to the calendar view (window) positioned above the tasks. As this happens the listing of tasks in urgency order gets smaller because the tasks can now be accounted for by a resource and time slot. In the calendar presentation, scheduler can show the normal work hours of each person, any meetings they have and any time off that they've scheduled. Scheduler provides an exact representation of the status of the resources and availability.

The urgency factor can be utilized to prioritize your work without a single identifier that says critical. For example, each task within a series of tasks may each be dependent on the prior task being completed before it can be performed. If there is a dependency and the prior task has not been completed then a given task's urgency will likely drop because a field service person can't work on it anyway. The urgencies create a hierarchy of tasks and the user can take the top task, and match the task with the appropriate work groups and assign them out. Once the task is assigned and expanded over the appropriate time duration, the appropriate resources and time slots are booked and the data can be shared to other participants in the p2p network in a real time manner such that the appropriate data in the various peripheral systems are updated.

Therefore, once tasks are assigned, alerts can be sent out to the responsible work group or to the individual field service person by way of their mobile device. Also, real time update allows the dispatcher, field service personnel, customer service representatives, managers and others to know the real time status, be integrated and know what tasks they specifically have to perform and when. For example, a field service person can access the work management system at the beginning of their day via their mobile device and pull up all tasks to be performed in that workday. If their tasks are modified, alerts can be sent out. Also, location devices can be installed in the mobile devices or in service vehicles so that the location of the service person or other resource can be located at all times and uploaded in the work management system. Each time information is updated, a notification can be sent out to all participants in the p2p network along with a task type. Each participant or user of the system can determine if the task type requires it to take some action. If tasks are unable to be completed at the end of the day (other emergencies or issues), these tasks are then unassigned and distributed back into the work management system so that they can be reprioritized and distributed again.

An alternative screen view that can be accessed by the user is a map screen view where the user can see the location of personnel and resources by local as identified as icons on a map displayed on the screen. Often, the location of a resource is important in servicing orders to assure most efficient use of time and travel. A task can be dragged and dropped in a similar manner to assign a task. As emergency tasks arise, dispatchers are able to see who is the closest resources and drag the emergency task onto that resource. Resources can include workgroups or individuals having a certain expertise, fixtures such as meters or trucks equipped with certain necessary items to perform a task. All of these resources can be in view with the user interface of the scheduler application and/or automatically allocated and scheduled base on other resources being allocated.

The details of the invention and various embodiments can be better understood by referring to the figures of the drawing. Referring to FIG. 1, an illustration of the physical topology on which the applications reside is shown. The Work Management system keeps track of service orders, assignment and scheduling of tasks. It also serves as a container for metrics and as a prioritizer for work distribution. The Consumer Information System (CIS) keeps track of the details of the work that need to be performed. All updates to work management or CIS can be done through webservices. Client Desktop Applications can use web services or Java RMI for standard data sync. The Work Management System 100 and the CIS 102 and the Relational Database Application 104 and associated electronic memory media can reside on the same server hardware 106 or server hardware environment or alternatively can be segregated on separate servers or separate server environments. CIS allows a user to access consumer account information and access a service request template and associated rules for generating a service order responsive and initiated by a consumer request for service. For example, in the case of the utility industry, a consumer may request a new service or modification to service.

A Customer Service Representative (CSR) can pull up the consumers account information and any templates or associated rules in order to input information regarding a service request. Once a service request is entered a service order can be generated based on the inputs for the service request. The service order data can be communicated to the Work Management System (WMS) 100 and the WMS can interpret information contained in the service order to create a work flow, which contains a list of task to be performed. The WMS can retrieve selected task data tables from the relational database where the task are selected based on rules retrieved from the service order. The WMS can build a workflow from the task retrieved and the task tables in the list can be constructed and populated with the appropriate information consistent with the service order. The work flow can be stored and communicated over the P2P network to the appropriate participants.

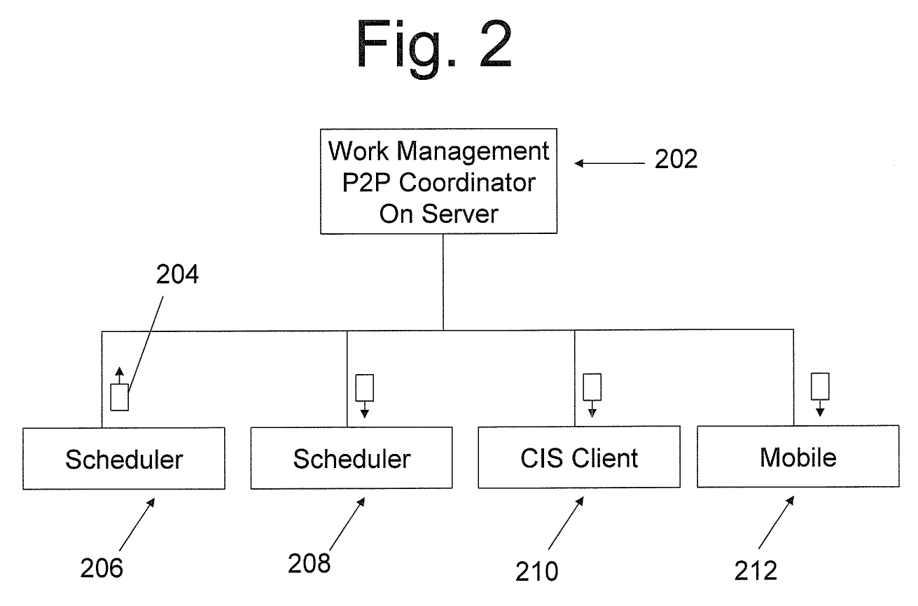

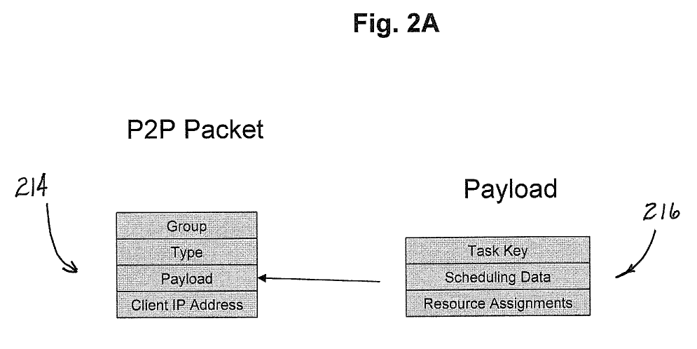

Referring to FIG. 2, an illustration of a peer-to-peer network environment including various participants within the work management function is shown. The WMS can include a p2p Coordinator function 202, which coordinates the p2p data traffic to and from the various applications. The data can be in the form of data packets 204, transmitted to and from the application desktops and the server on which the WMS resides. As each application modifies tasks, the server on which the WMS resides can send out p2p messages to other clients so they stay in sync. A user can manipulate a Task using the user interface of the Scheduler Desktop Application. Once the Task has been operated on by the user, the scheduler application can send the updated Task information (such as calendar and resource assignment) to the server. This can include a series of packets including a definition of schedule and resource allocations. Once the server has the updated information, the updated information can be committed to the Database. Once the updated information has been committed to the Database, a change notification packet or series of packets can be sent to all participants or clients on the network using the p2p transport mechanization. All participants can be operable to receive the updated information contained in the packets, but each participant can be operable to interpret whether an individual action is required, because not all participants will need to react since the data may not be applicable to every participant on the network.

Client applications can also talk over a p2p system for pushes of data rather than relying on standard pulls. The Scheduler desktop application, 206 and 208, can reside and operate on a standard desktop computer and can be operable to receive data updates to sync with the other participants on the network in order to have the most up to date information. The Scheduler desktop application can also send updated information based on a user scheduling and assigning a task. The CIS Client application 210 can also reside and operate on a standard desktop computer. The CIS Client application can receive data updates as well when tasks have been scheduled such that a CSR has the ability to inform a consumer of the scheduled time. The Mobile Client application 212 can reside and operate on a handheld computing device having a keyboard and display. The Mobile Client application can receive data updates when tasks have been scheduled and assigned.

Referring to FIG. 2A, an illustration of p2p data packets is provided, however is representative example and in no way considered to limit the scope of the present application or the use of packets. Packets can be sent over the network using TCP/IP. Each p2p data packet 214 can contain various elements including the IP address of the client, group, type and the payload 216. The p2p clients register in groups (String Name) in order to prevent cross talk. The type refers to the type of p2p Client.

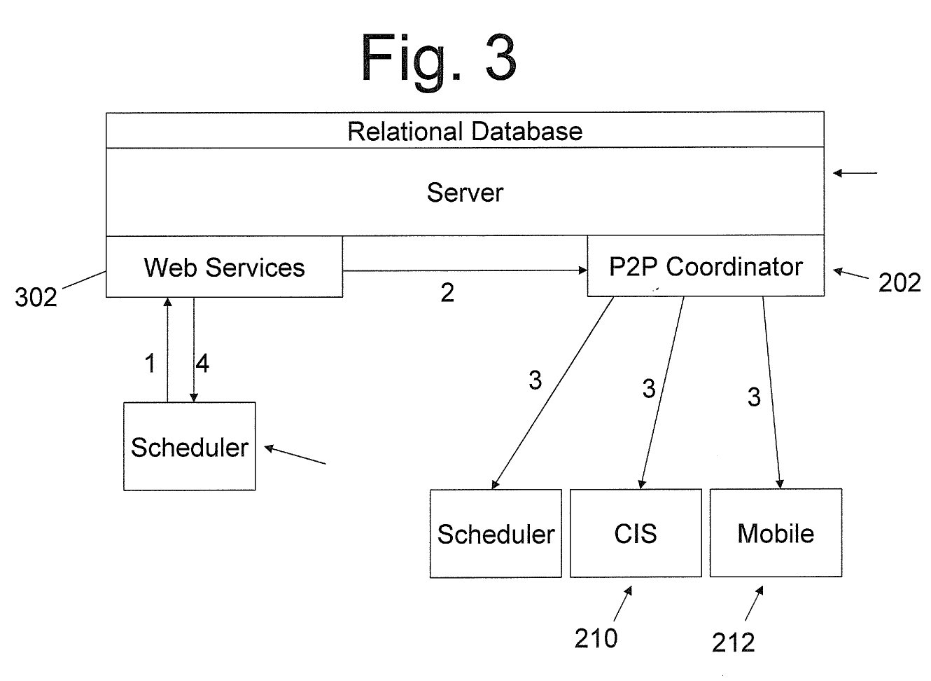

Referring to FIG. 3, an illustration of how the scheduler, mobile and Work Management System participate with p2p, Web Services and RMI is shown. When a Scheduler updates a task, it can send a message to the server on which the WMS resides through Web Services. After the transaction has committed the updated task, it can notify the p2p Coordinator that a task has been update. The p2p coordinator can then send a message to all other desktop applications running work management pieces and can let them know the updated information that they might want to update. Once the transaction is complete and the p2p notification is sent, the synchronous update can return to the original client and confirming that all clients are now in sync. The Web Services 302 function can reside on the Work Management and Business Applications server and can act as a conduit between the Scheduler Desktop applications and the Work Management application.

Web services provide a standard means of interoperating between different software applications, running on a variety of platforms and/or frameworks. A Web Service is a software system designed to support interoperable machine-to-machine interaction over a network. It has an interface described in a machine-processable format. Other systems interact with the Web service in a manner prescribed by its description using messages, typically conveyed using HTTP with an XML serialization in conjunction with other Web-related standards. A Web service is an abstract notion that must be implemented by a concrete agent. The Web Services function can receive information from the Scheduler Desktop and communicate the information to the Work Management System and store the information in a relational database. The P2P coordinator can coordinate sending up to date information regarding the schedule. The server can host both the Work Management Application and the Business Applications, which can be partitioned in software.

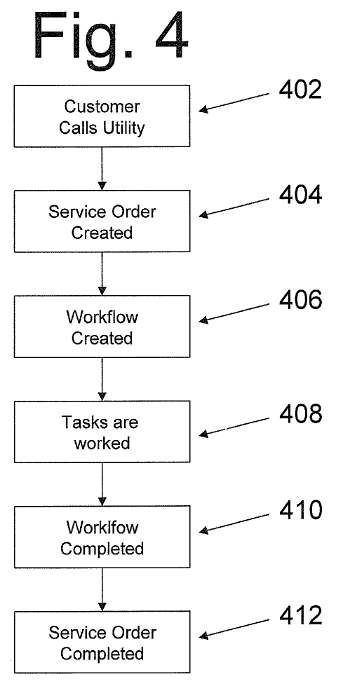

Referring to FIG. 4, an illustration of how to create a service order, generate a workflow of tasks and complete the work flow is shown. As indicated above the present invention could be utilized in the utility industry to manage and schedule resources responsive to maintenance requirements, infrastructure improvement requirements, emergency response requirements and consumer requests. The flow shown in FIG. 4 is a simplified illustration of a consumer request. For example, an energy consumer can call or visit a power company 402 looking for new service or to update their existing service. Based on the input from the consumer, a service order can be created 404 using, for example a CIS Business Application, that describes the work and equipment to be performed. This can typically be a new Meter, Transformer or Security Light on their property.

The workflow engine of the Work Management System can examine the service order and can create a series of tasks 406 to be completed for the service order. This workflow can contain tasks like—calculate materials, install meter, inspect work or call the customer/consumer. As the tasks are worked 408, each one can have a status set such as Open, Complete, Cancelled, Delayed or In Progress. Some tasks can be considered critical when downstream tasks require that they be done in order. These tasks can typically be assigned and scheduled through Scheduler. After all the tasks have reach a conclusion 410 the status can be updated to reflect Complete or Cancelled. The workflow can be considered complete. Some workflows might be cancelled at the consumer's request or that the service could not be completed. Once the workflow has run its course, the service order will have a status set on it that defines what actually happened. In most cases it is Complete 412 and the consumer is notified that the request service work has been completed.

Referring to FIG. 5, an illustration of the flow for dispatching work by downloading and scheduling tasks is shown. The Scheduler Desktop Application can be started on a desktop PC client 502 in the exact same state it was previously shut down. This allows the user to set up the user interface view that is most applicable to their function in the organization. The user can run the application in a multi-monitor mode. The user can also setup multiple views or tabs in the browser like interface such that different windows or views can be displayed on each monitor within the multi-monitor setup. This allows the user to place multiple windows on multiple monitors using a system for dispatching that is specific to their organization. The task list can be downloaded 504 by the desktop client from the server. These are tasks that have not been scheduled, but may have already been assigned to a specific resource or a workgroup. The user can then set a variety of filters 506 such as locality, task type, workgroup or free form filter (like “Pine Street”).

One of the columns in the task list table is called Urgency. The task can be sorted by urgency 508. This urgency factor (1 . . . 100) provides the task priority, needed date and status in the workflow to determine how important it is for that task to be worked. If a task does not need to be completed for two months, the task will usually have a very low score. A task that requires completion within a few days will typically have a very high score. In some cases a task could be important however an upstream task that needs to be completed before the workflow can proceed will keep the score down so the user can focus on the appropriate tasks. The user can schedule and assign task 510 by dragging the tasks up into one of 4 different calendar views and then drag a resource on task to assign it. When the user has shut down the application 512, all tabs, windows, filters and resources are remembered for the next startup (typically the next day). Alternatively, the user can use the first available function for step 5 which speeds up their process by narrowing down potential resources and time slots without the user having to hunt through the schedule for the appropriate spot.

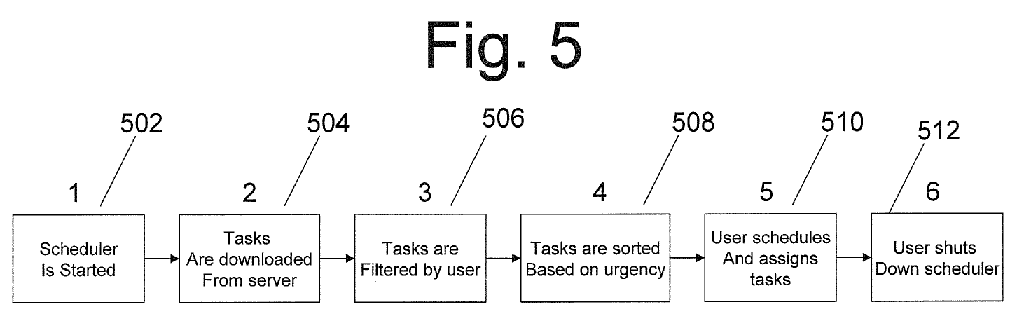

Referring to FIG. 6, an illustration of a screen shot of the Workgroup Resource/Calendar View with the task queue in view is shown. The Workgroup resource window 602 is shown, which lists 604 each of the members in the Workgroup. The name of each member 606 of the Work Group and each name is shown with a color-coded icon 608 representative of the individual. A monthly calendar 610 is shown adjacent the Work Group Window with one task 612 already assigned, thus not appearing in the task queue 614 below. A task 616 can be clicked on and the user can drag the task and place it on the appropriate day and expand the task icon 618 to cover the desired time frame. The user can then click on an icon for the individual and drag it over to the task just scheduled. The task is now automatically scheduled by the scheduler application with a resource designated. The scheduler application can then generate a data packet or a series of data packets representative of the scheduled task and allocated resources. The data packet(s) can be sent to the server and the WMS system can interpret the packets and commit the appropriate information to the database and can send update packets to all of the participants on the network.

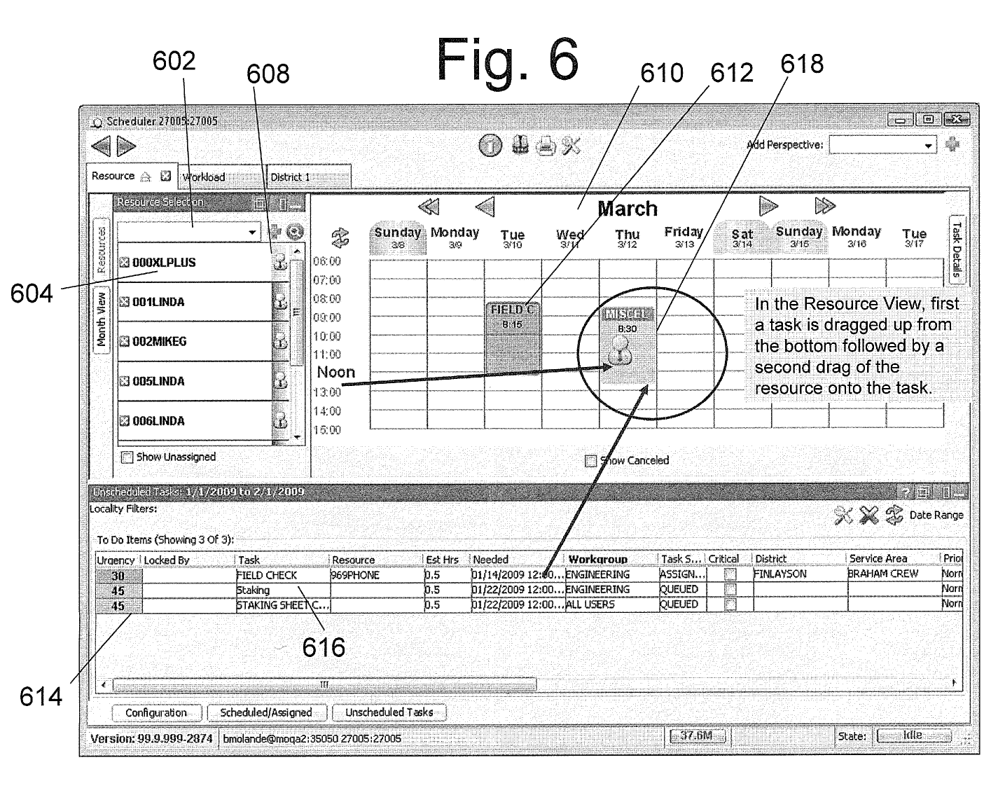

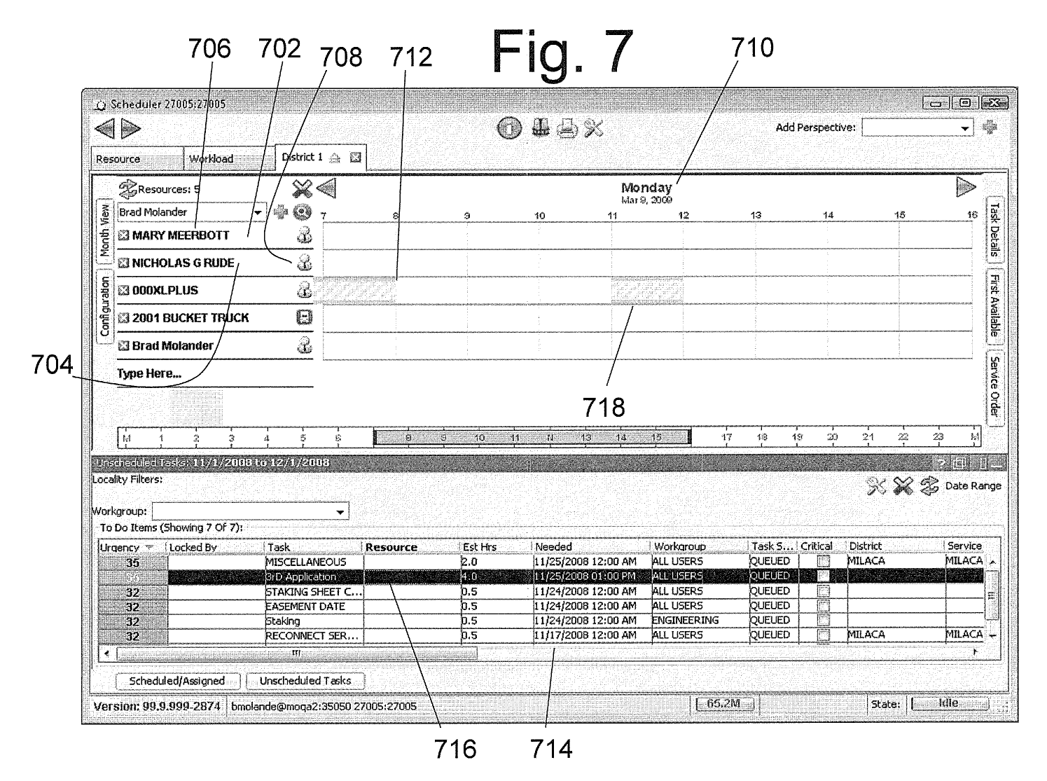

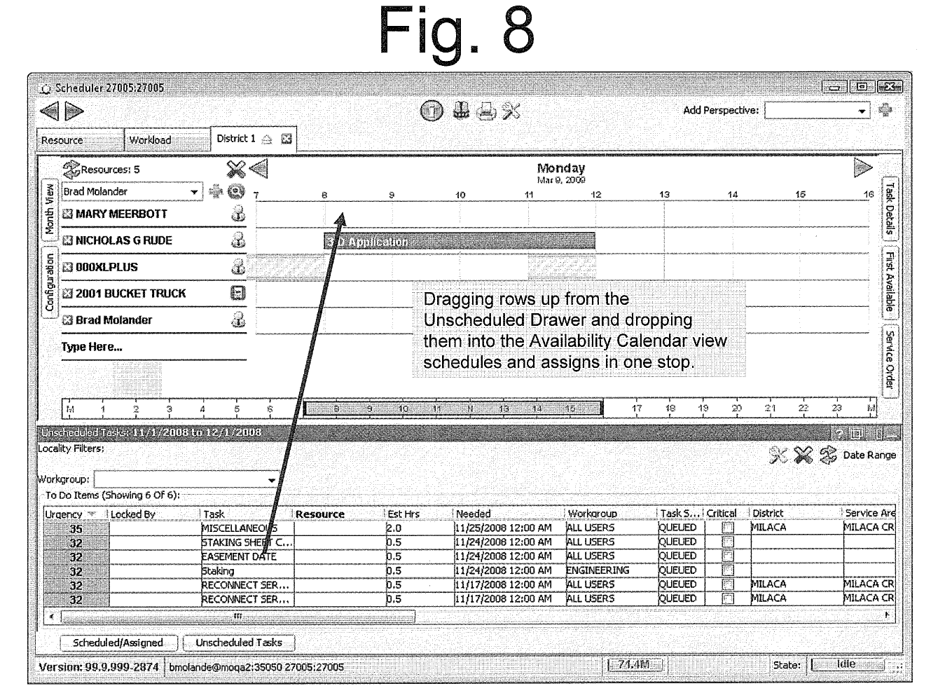

Referring to FIGS. 7 and 8 an illustration of a screen shot of the Individual Resource/Daily Calendar View with task queue in view is shown. The Workgroup resource window 702 is shown, which lists 704 each of the members in the Workgroup. The name of each member 706 of the Work Group and each name is shown with an icon 708 representative of the individual. A daily calendar 710 is shown adjacent the Work Group Window with one item 712 already scheduled, thus the time slot is not available for that individual. A task 716 in the task queue 714 can be clicked on and the user can drag the task and place it on the appropriate time slot and expand the task icon 718 to cover the desired time frame. The user can then click on an icon for the individual and drag it over to the task just scheduled. The task is now scheduled with a resource designated.

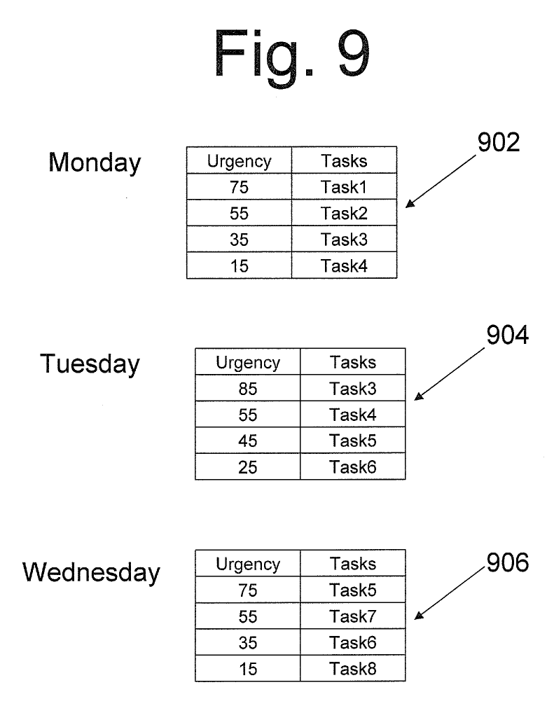

Referring to FIG. 9, an illustration of task tables showing urgency flow is shown. Each data package representative of a task can have imbedded therein or associated therewith an urgency factor, which can be designed to be within the range of 1 . . . 100. The assigned urgency factor can be based on various parameters including due date, estimated time to complete task, prerequisite task completion, age of request and other parameters. In the initial state 902 there are four tasks to schedule. In this simple example the assumption is that only two tasks can be scheduled a day. The user will typically choose the top two since their urgency factor is the highest. The user can drag Task1 and Task2 from the bottom drawer or window displaying the task list or queue up into the calendar view to the appropriate time slot and resource to perform the work. In the second state 904, two more tasks have shown up, but have low urgency factors because they are new. Task3 and Task4 are now at the top because a day has gone by and they are now considered more urgent. Since the factor number is calculated on a variety of fields (and in some cases scripted by the user) the factors do not follow a pattern that the user can discern. In the third state 906, Task6 will not be worked because another task (Task7) has a higher urgency factor. Since the factors that are considered can vary, the user does not need to be concerned with why or how. They simply need to know that Task7 is more important that Task6 at this point in time.

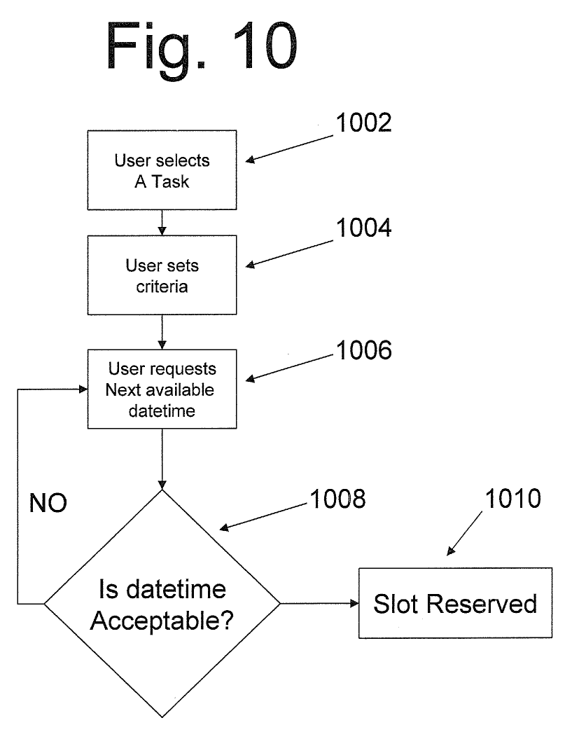

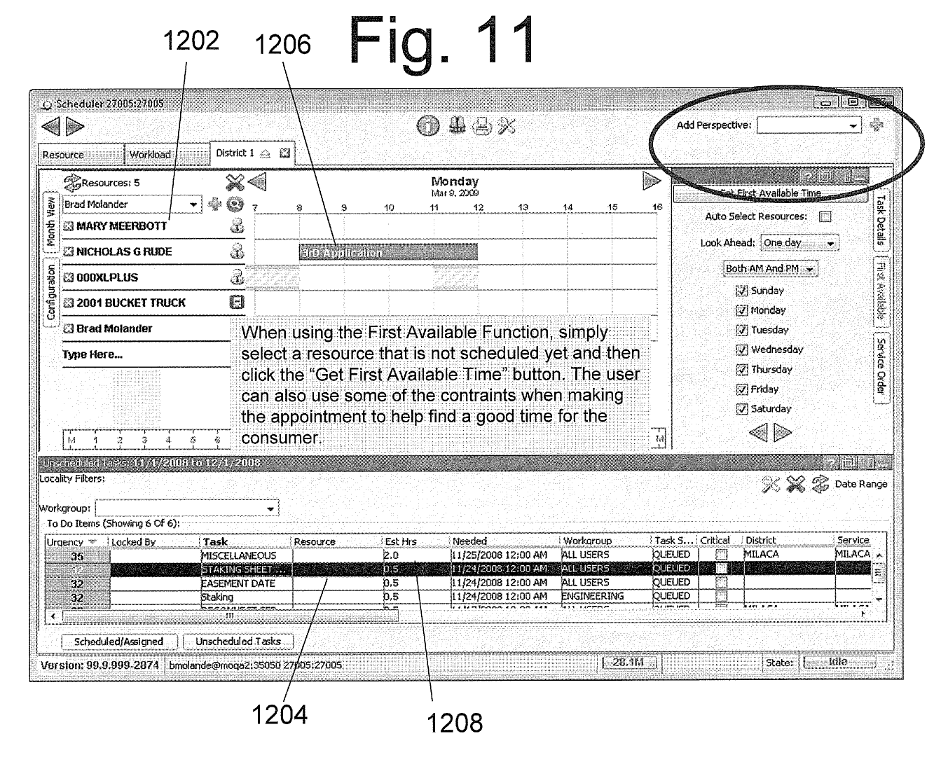

Referring to FIG. 10, an illustration of the First Available flow for assigning tasks is shown. The First Available algorithm checks the tasks and workgroup and looks for resources in the workgroup or workgroups that can perform the selected task. The user can select a task 1002 for, which to find the first available time slot. The user can set criteria 1004, such as when a task has to be completed or the time required to perform the task or special equipment or expertise is required to perform the task. When the user request next time available 1006 and the algorithm begins searching for a slot, the algorithm can check all resources assigned to that workgroup, check's each resources' work hours, time off, meetings and other tasks, check's for holidays and check's to make sure timeslot chosen fits the estimated time for that task. The time slot is presented to the user and if the time slot presented is acceptable to the user 1008, then the slot can be reserved 1010. At the conclusion when the slot is reserved, a P2P message is sent out (task updated) to all other schedulers on the network. This allows the schedulers to stay in sync within 10-20 milliseconds and helps prevent against a data collision (double booking. FIG. 11 is a screen shot illustrating the First Available function. When using the First Available function, the user can simply select the resource that is not scheduled and then client the “Get First Available Time” button. The user can also use some of the constraints when making the appointment to help find a good time for the consumer.

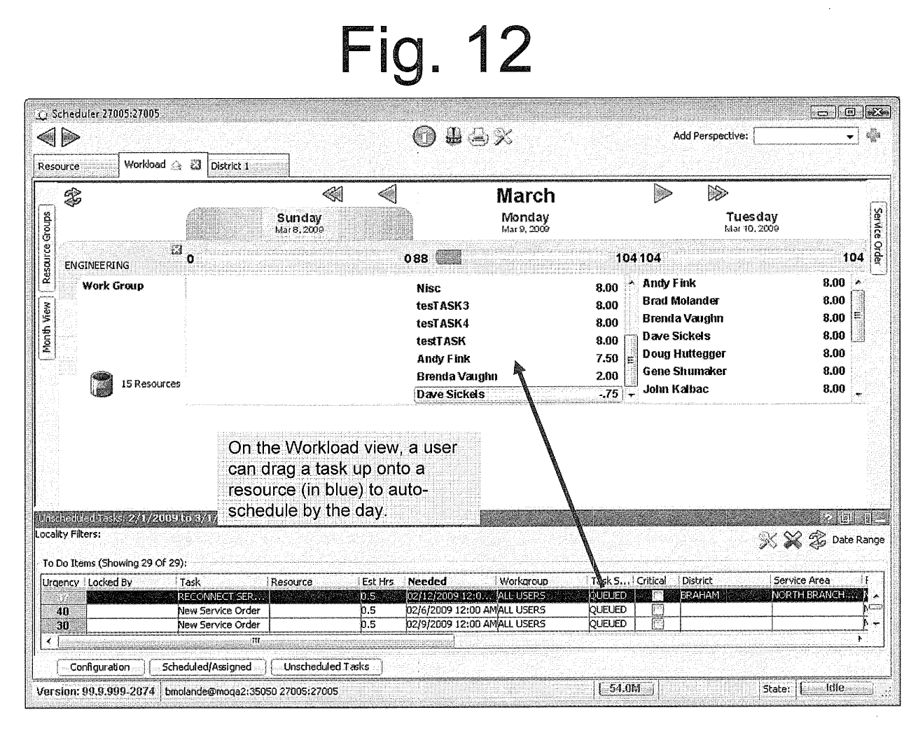

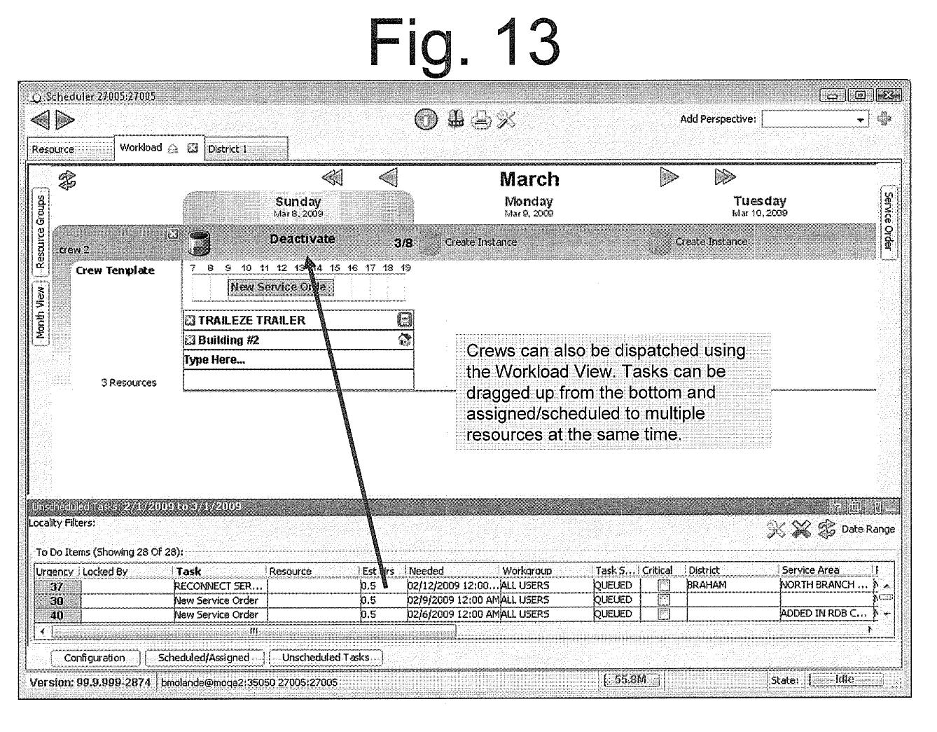

Referring to FIG. 12, a screen shot illustrating a Workgroup Workload View with tasks in view is shown. This view shows the work load in a group 902 on a given day. In this view the user can click on and drag a task 904 up to the resource 906, as high-lighted, to automatically schedule by the day and assigning the estimated time 908 to complete. FIG. 13 is a further screen shot illustrating a Crew Template of the Workgroup Workload View with tasks in view. Crews can be dispatched using this Workload view. Tasks can be dragged from the bottom and assigned/scheduled to multiple resources at the same time.

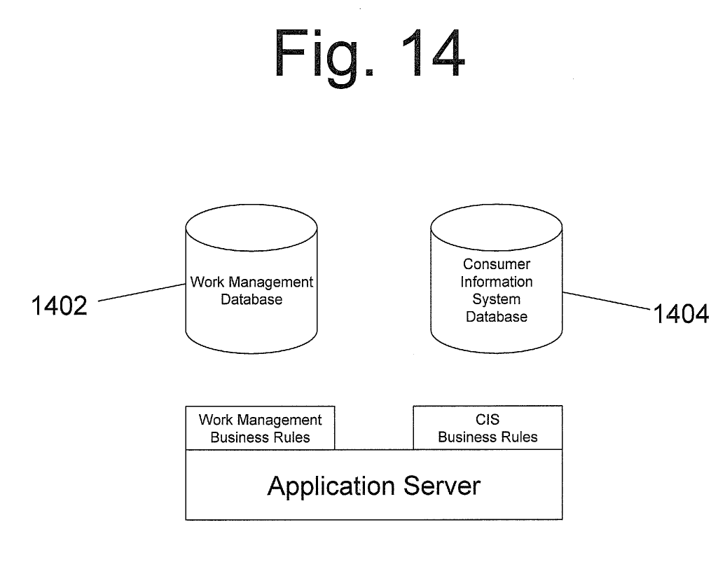

Referring to FIG. 14, an illustration of the overall data flow is shown. The Work Management Database 1402 and the CIS Business Applications Database 1404, can be hosted on the same hardware and partitioned in software. The Application server, which can host the Work Management Application and the CIS Business Applications can have a set of Work Management and CIS Business rules for data handling. Work Management can contain tasks, resources and workflows. The Work Management System isn't required to have knowledge of service orders or other aspects. CIS Business Rules can also include Service Orders. Service orders can contain a workflow ID that maps them to a workflow in the Work Management System.

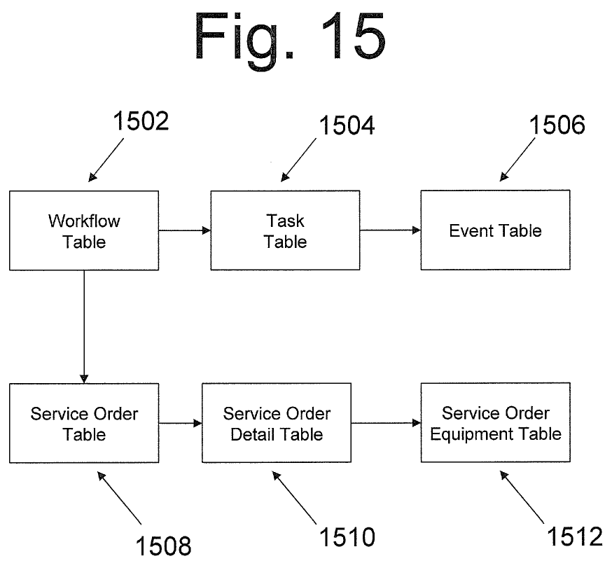

Referring to FIG. 15, an illustration of the overall data implementation schema is shown. The Work Flow Table 1502 can be created based on the workflow which can be determined by a service request. The Work Flow Table can list the Task to be performed in order to be responsive to the service request. The Task Table 1504 has all of the specific criteria for the task. The Event Table 1506, which is based on the Task Table, and which contains the assignment and scheduling information. Each task can be assigned and scheduled multiple times. Each Service Order Table 1508 can have a detail record that describes the type of service work being performed (Electric or Propane or . . . ). Each Detail can have multiple equipments attached. Therefore there is a Service Order Detail Table 1510 and a Service Order Equipment Table 1512. Each Workflow can have more than one service order attached. Typically this is 1:1. The Service Order can keep track of the details of the work to be performed.

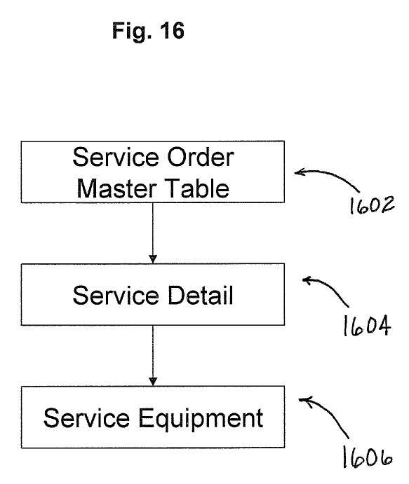

Referring to FIG. 16, an illustration of the Service Order Table Flow is shown. Service Order Table 1602 can contain top level information such as customer information and the Service Order Number. If the consumer has multiple service types, such as electric and natural gas, a Service Detail 1604 can be created for each. This can contain account information for billing and locale. For each detail record, Service Equipment 1606 may be specified that informs the field resource what work is involved with the Order and required equipment.

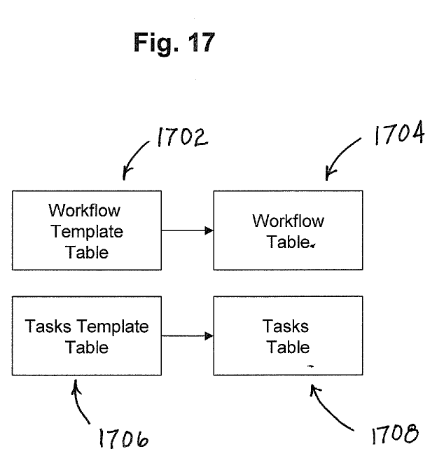

Referring to FIG. 17, an illustration of the Data Template Schema is shown. When a workflow is created, a template 1702 can be used to frame the tasks that typically reside in that workflow. The template for workflow 1704 can dictate the series of tasks to complete the work requested. The template for the tasks table 1706 can dictate the attributes of the task. For instance—what group of resources (including individuals with particular expertise and associated equipment resources) typically works the task, how long the tasks typically takes and how many resources are needed to work it. Once the tasks have been recreated in the Task Implementation Tables 1708, they are effectively ready to be worked.

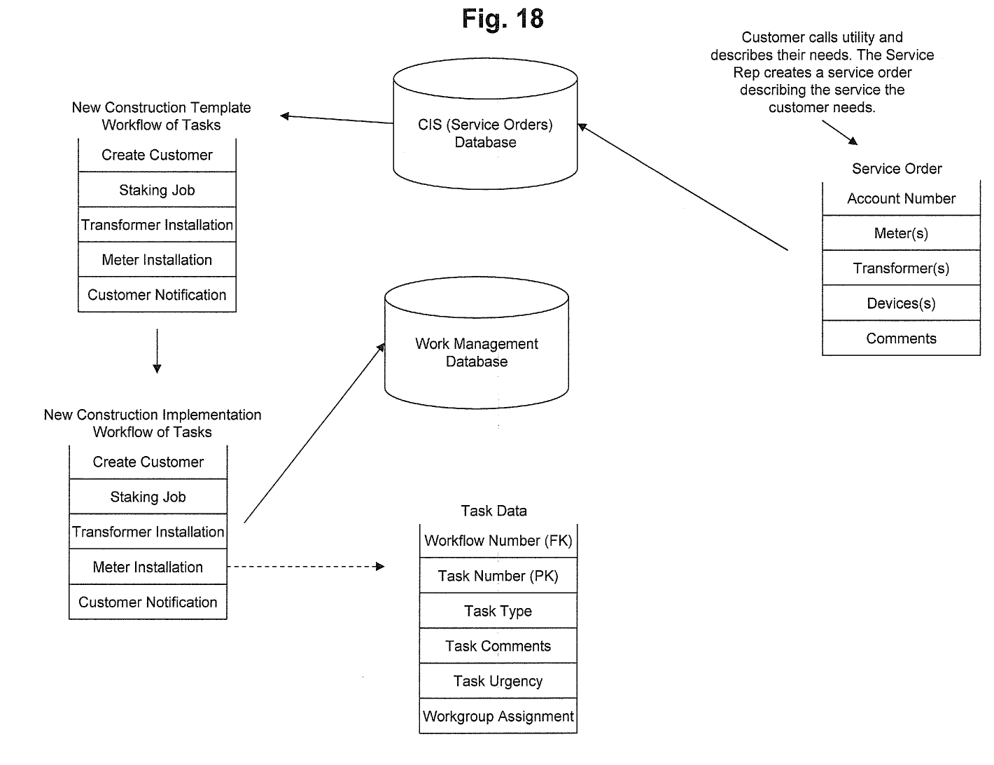

Referring to FIG. 18, an illustration of the flow of Data Templates and Data Tables are shown. By way of example, an End Consumer can call into a utility provider's customer service line or log onto a web site and describe their need or request for service. A Service Representative can create a Service Order, which describes the Consumers request and need. The service order can be created by entering information at a client desktop where such information can include the Consumer's account number, various information regarding the current service and requested service including meters and transformers and can include comments and inputs directed to and identifying the requested service. The information can be processed by the business application and stored in the business application database. A work flow template of tasks and the Implementation Workflow of tasks can be created based on the service order and the type of service being requested. The Work flow can be utilized by the work management system to create the task data tables. The task data table can include a reference number back to the workflow, workgroup assignment and can include a task number and task types.

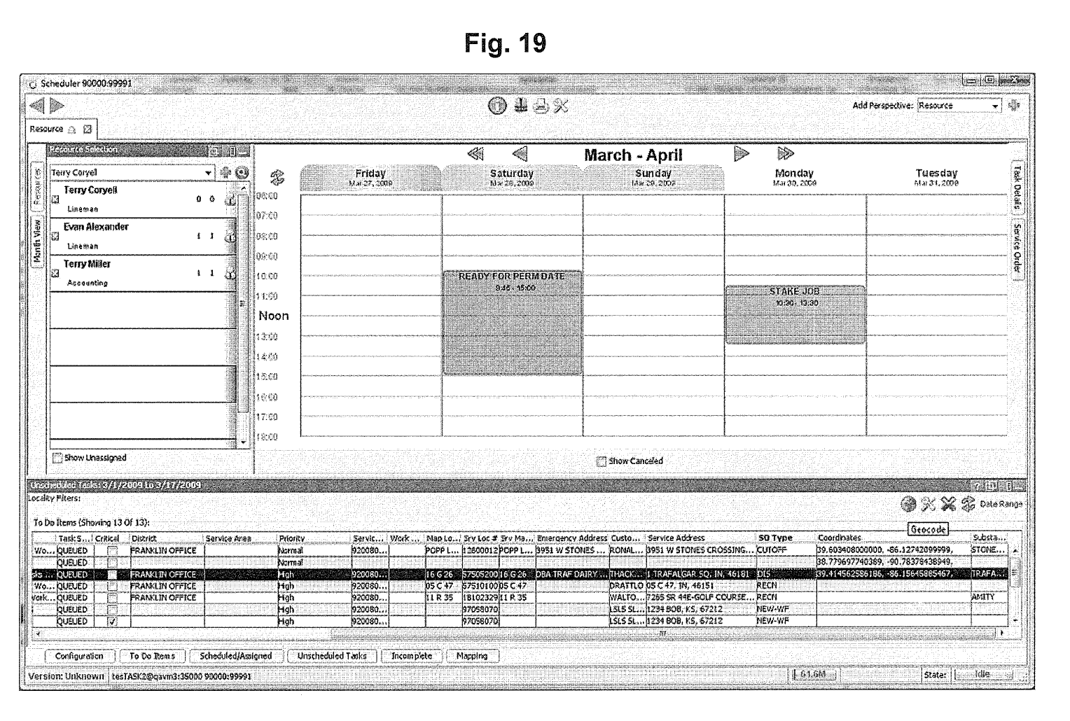

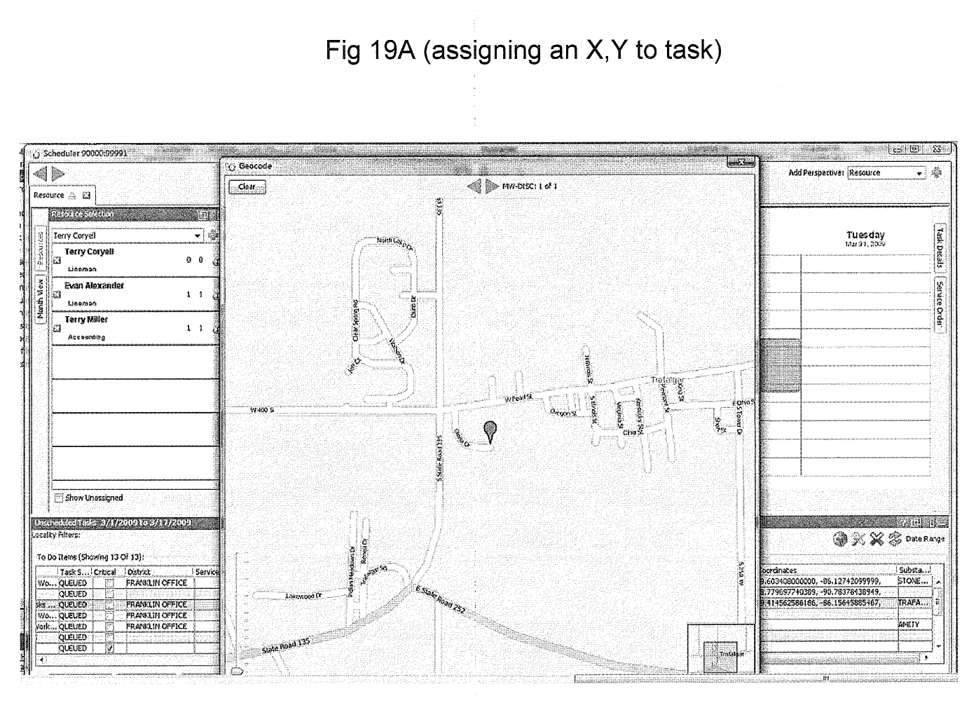

Referring to FIGS. 19 and 19A, a screen shots illustrating Geo-Tagging are shown. An alternative screen view that can be accessed by the user is a map screen view where the user can see the location of personnel and resources by locale as identified as icons on a map displayed on the screen. Often, the location of a resource is important in servicing orders to assure most efficient use of time and travel. A task can be dragged and dropped in a similar manner to assign a task. As emergency tasks arise, dispatchers are able to see who is the closest resources and drag the emergency task onto that resource icon identified on the map view. Resources can include workgroups or individuals having a certain expertise, fixtures such as meters or trucks equipped with certain necessary items to perform a task. All of these resources can be in view with the user interface of the scheduler application and/or automatically allocated and scheduled base on other resources being allocated.

Geocoding of tasks based on customer discussions can also be performed. One of the tasks in the workflow can ask a customer service representative (CSR) to geo-tag a task to a specific location. The process can prompt the CSR to place a flag on a map displayed graphically so that the service technician knows where to perform their task (further down in the workflow). This process is critical to routing and workload planning in terms of lower drive times and fuel costs. Task assignments and scheduling can be made with location of the work site and location of the resource in view. Using a multi-monitor function, a user can view the calendar/resource/task screen format on one monitor while simultaneously viewing the map/resource location/task screen format on another monitor. Any update resulting from this users input or any other users input will be updated on both screens in a next to real time manner using the p2p type architecture.

The various scheduling application examples shown above illustrate a new scheduling. A user of the present invention may choose any of the above embodiments, or an equivalent thereof, depending upon the desired application. In this regard, it is recognized that various forms of the subject system and method could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A computer-implemented method for generating a schedule for a task list to be performed and allocation of resources, the method comprising the steps of:
inputting customer request data into a client desktop;
transmitting the customer request data from the client desktop to a server over a p2p type network, where said server is communicably linked to a relational database and said server has a work management application executing thereon and a business application executing thereon, where said work management application is a running p2p coordinator function, a scheduler function and a mobile function;
creating with the work management application a work flow including a task and electronically storing the task in the relational database;
starting a scheduler desktop application on a scheduler desktop and launching a browser like graphical user interface having a workgroup window including a graphical representation of a resource, a calendar window including a graphical representation of available and booked time slots and a task queue window including a graphical representation of the task in view;
downloading from the server the task over the p2p network to the scheduler desktop and displaying the graphical representation of the task in the task queue window;
clicking on the graphical representation of the task and dragging a task icon representative of the task to the calendar window and placing the task icon in an appropriate available time slot;
booking the appropriate available time slot and uploading to the server over the p2p network the task schedule data representative of the booked time slot and updating an event schedule in the relational database; and
transmitting the updated event schedule data to all participants on the p2p network and presenting the updated schedule in the schedule window.

2. The computer implemented method as recited in claim 1, where the calendar window is displayed on a monthly format showing days of the week and hourly time slots for each day.

3. The computer implemented method as recited in claim 1, where the task is assigned an urgency factor.

4. The computer implemented method as recited in claim 1, further comprising the step of filtering the task based on user selected criteria to determine whether to display in the task queue window

5. The computer implemented method as recited in claim 1, further comprising the step of executing a first available function of the scheduler desktop application to automatically determine next available time slot based on user selected criteria.

6. A computer-readable medium encoded with computer-executable instructions for controlling a computer system having a user interface to perform a method to generate a schedule for a task list to be performed, where when said instructions are executed said computer system performs a method comprises the steps of:
transmitting customer request data from client desktop to a server over a P2P type network, where said server is communicably linked to a relational database and said server has a work management application executing thereon and a business application executing thereon, where said work management application is running a P2P coordinator function, a scheduler function and a mobile function;
allowing a user to start a scheduler desktop application on a scheduler desktop and to thereby launch a browser like graphical user interface having a workgroup window including a graphical representation of a resource, a calendar window including a graphical representation of available and booked time slots and a task queue window including a graphical representation of a task in view;
allowing the user to download from the server the task over the P2P network to the scheduler desktop and displaying the graphical representation of the task in the task queue window;
providing functionality to allow the user to click on the graphical representation of the task and drag a task icon representative of the task to the calendar window and place the task icon in an appropriate available time slot;
providing functionality to allow the user to book the appropriate available time slot and upload to the server over the P2P network the task schedule data representative of the booked time slot and update an event schedule in the relational database; and
receiving the updated event schedule data to the scheduler desktop over the P2P network and presenting the updated schedule in the schedule window.

7. The computer-readable medium with computer-executable instructions for controlling a computer system to generate a schedule as recited in claim 6, where the calendar window is displayed on a monthly format showing days of the week and hourly time slots for each day.

8. The computer-readable medium with computer-executable instructions for controlling a computer system to generate a schedule as recited in claim 6, where the task is assigned an urgency factor.

9. The computer-readable medium with computer-executable instructions for controlling a computer system to generate a schedule as recited in claim 6, further comprising the step of:
providing a filtering option to the user allowing the user filter the task based on user selected criteria to determine whether to display in the task queue window.

10. The computer-readable medium with computer-executable instructions for controlling a computer system to generate a schedule as recited in claim 6, further comprising the step of:
executing a first available function of the scheduler desktop application to automatically determine next available time slot based on user selected criteria.

11. A computer system for generating a schedule for a task list to be performed, comprising:
a client desktop having an input device and operable to receive inputted customer request data through said device and said client desktop operable to transmit the customer request data from the client desktop to a server over a P2P type network, where said server is communicably linked to a relational database and said server has a work management application executing thereon and a business application executing thereon, where said work management application is running a P2P coordinator function, a scheduler function and a mobile function;
a scheduler desktop having a scheduler desktop application running thereon and providing a browser like graphical user interface displaying a workgroup window including a graphical representation of a resource, a calendar window including a graphical representation of available and booked time slots and a task queue window including a graphical representation of the task in view;
said scheduler desktop application running on said scheduler desktop operable to download from the server the task over the P2P network to the scheduler desktop and display the graphical representation of the task in the task queue window;
said desktop having a selection device operable to allow the user to select the graphical representation of the task and drag a task icon representative of the task to the calendar window and place the task icon in an appropriate available time slot;
said scheduler desktop application further operable to book the appropriate available time slot and upload to the server over the P2P network the task schedule data representative of the booked time slot and update an event schedule in the relational database; and
said server operable to transmit the updated event schedule data to all participants on the P2P network and presenting the updated schedule in the schedule window.

12. The computer system as recited in claim 11, where the calendar window is displayed on a monthly format showing days of the week and hourly time slots for each day.

13. The computer system as recited in claim 11, where the task is assigned an urgency factor.

14. The computer system as recited in claim 11, further comprising a filter operable to filter the task based on user selected criteria to determine whether to display in the task queue window

15. The computer system as recited in claim 11, further comprising a first available function of the scheduler desktop application operable to automatically determine next available time slot based on user selected criteria.

16. A computer-implemented method for generating a scheduler user interface for task scheduling and resource allocation, the method comprising the steps of:
presenting to a user a task view window within a user interface screen displayed on a scheduler desktop computing system where the desktop computing system is a participant in a p2p type network and where the task view window graphically lists a task icon representative of a task to be performed, which is part of a workflow generated based on inputting customer request data into a customer service client desktop defining a service order;
presenting a workgroup and resource window within said user interface screen where the workgroup and resource window graphically lists a resource icon representative of a resource;
presenting a calendar window within said user interface screen where the calendar window includes a calendar graphically illustrating a scheduled event and a scheduled task and available time slots for the resource;
providing a user interface function operating on the scheduler desktop computing system operable to allow a user to click on the task icon, drag and drop said task icon in one of said available time slots and further to allow the user to click on the resource icon, drag and drop said resource icon on the task icon;
automatically booking the appropriate available time slot and resource for the task in task schedule data using a scheduler application operating on said scheduler desktop computing system and uploading to a server over the p2p network the task schedule data representative of the booked time slot and updating an event schedule in a relational database communicable with said server; and
transmitting the updated event schedule data to all participants on the p2p network and presenting the updated schedule on the user interface.

17. The computer implemented method as recited in claim 16, where the calendar window is displayed on a monthly format showing days of the week and hourly time slots for each day.

18. The computer implemented method as recited in claim 16, where the task is assigned an urgency factor.

19. The computer implemented method as recited in claim 16, further comprising the step of filtering the task based on user selected criteria to determine whether to display in the task queue window

20. The computer implemented method as recited in claim 16, further comprising the step of executing a first available function of the scheduler desktop application to automatically determine next available time slot based on user selected criteria.

21. A computer-readable medium encoded with computer-executable instructions for controlling a computer system having a user interface to perform a method to generate a schedule for a task list to be performed, where when said instructions are executed said computer system performs a method comprises the steps of:
presenting to a user a task view window within a user interface screen displayed on a scheduler desktop computing system where the desktop computing system is a participant in a p2p type network and where the task view window graphically lists a task icon representative of a task to be performed, which is part of a workflow generated based on inputting customer request data into a customer service client desktop defining a service order;
presenting a workgroup and resource window within said user interface screen where the workgroup and resource window graphically lists a resource icon representative of a resource;
presenting a calendar window within said user interface screen where the calendar window includes a calendar graphically illustrating a scheduled event and a scheduled task and available time slots for the resource;
providing a user interface function operating on the scheduler desktop computing system operable to allow a user to click on the task icon, drag and drop said task icon in one of said available time slots and further to allow the user to click on the resource icon, drag and drop said resource icon on the task icon;
automatically booking the appropriate available time slot and resource for the task in task schedule data using a scheduler application operating on said scheduler desktop computing system and uploading to a server over the p2p network the task schedule data representative of the booked time slot and updating an event schedule in a relational database communicable with said server; and
transmitting the updated event schedule data to all participants on the p2p network and presenting the updated schedule on the user interface.

22. The computer implemented method as recited in claim 21, where the calendar window is displayed on a monthly format showing days of the week and hourly time slots for each day.

23. The computer implemented method as recited in claim 21, where the task is assigned an urgency factor.

24. The computer implemented method as recited in claim 21, further comprising the step of filtering the task based on user selected criteria to determine whether to display in the task queue window

25. The computer implemented method as recited in claim 21, further comprising the step of executing a first available function of the scheduler desktop application to automatically determine next available time slot based on user selected criteria.
